(19) United States
(12) Patent Application Publication
(10) Pub. No.: US 2011/0263465 A1
(43) Pub. Date: Oct. 27, 2011

(54) Use Of Vinyl Phosphonic Acid For Producing Biodegradable Mixed Polymers And The Use Thereof For Exploring And Extracting Petroleum And Natural Gas

(75) Inventors: Christoph Kayser, Mainz (DE); Gernold Botthof, Antrifttal (DE); Juergen Tonhauser, Oestrich-Winkel (DE); Michael Schaefer, Gruendau-Rothenbergen (DE); Claudia Diemel, Gelnhausen (DE); Karl-Heinz Heier, Frankfurt am Main (DE)

(73) Assignee: CLARIANT FINANCE (BVI) LIMITED, Tortola (VG)

(21) Appl. No.: 13/141,883

(22) PCT Filed: Dec. 2, 2009
(86) PCT No.: PCT/EP2009/008585

§ 371 Date: Jun. 23, 2011

(30) Foreign Application Priority Data
Dec. 24, 2008 (DE) 10 2008 063 096.9

(51) Int. Cl. C09K 8/035; C09K 8/44; C09K 8/487; C08F 220/58; C08F 220/54; C08F 220/06; C08F 226/10; C08F 230/02

(52) U.S. Cl. 507/121; 526/264; 523/130

(57) ABSTRACT

The invention relates to the use of vinyl phosphonic acid or a salt thereof for improving the biodegradability of mixed polymers, comprising 25 to 99.5% by weight of structural units of one or more monomers selected from the group made of compounds of formula (1) and formula (3),

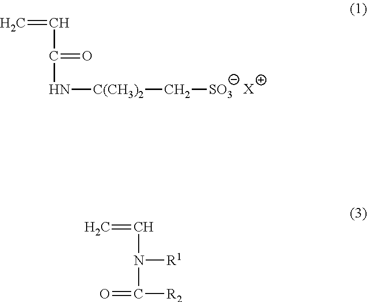

where R¹ and R² independently are hydrogen or C₁-C₄-alkyl, formula (4), where n is 3, 4, or 5, and formula (5),

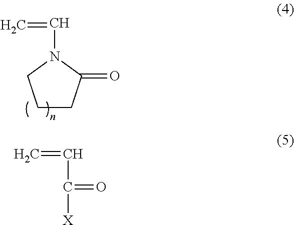

where X is OH or for NR³R⁴, and R³ and R⁴ independently are H or C₁ to C₄₋alkyl, in that 0.5 to 25% by weight of vinyl phosphonic acid is polymerized into the mixed polymer.

Use of vinyl phosphonic acid for producing biodegradable mixed polymers and the use thereof for exploring and extracting petroleum and natural gas

The present invention relates to the use of vinylphosphonic acid for the preparation of biodegradable copolymers comprising structural units derived from acrylamido-N-methylenepropenylsulfonates (AMPS), N-vinylamides and acrylic acid or derivatives thereof, and their use as additives in deep wells, cemented deep wells and completion and clearing-out liquids and for reducing the permeability of the water in the area close to the probe of petroleum or natural gas and water-conveying horizons.

In the area of deep-drilling technology, polymers perform various tasks in water-based drilling muds. Thus, they lead to a reduction of water loss especially when drilling through permeable formations by establishing a thin filter layer which seals the drill hole. In addition, they keep the resulting drillings in suspension by dispersion and thus help, inter alia, to transport the drillings above ground. Moreover, by using polymeric additives, the rheological properties of the drilling muds are changed; in particular, there is an increase in the viscosity and yield point. Especially fluid-loss additives for deep wells should have high thermal stability and little susceptibility to problems under highly saline conditions, in particular with respect to polyvalent cations, and should at the same time influence the rheological properties as little as possible since otherwise, when low water loss values are established, there is an undesired increase in the plastic viscosity and yield point.

After a certain section has been drilled, the casing is introduced into the borehole. The casing must then be fixed, i.e. a cement slurry which hardens with high strengths must be pumped into the annular space between the casing and the formation. The hardened cement must be impermeable to gases and liquids so that no gas and/or oil can flow out of the carrier formation into other formations or to the surface. The cement slurry to be pumped must meet very high requirements. It should be readily pumpable, i.e. of the lowest possible viscosity, and nevertheless not separate out. The release of water to the porous formation should be low so that the pumping pressure does not increase excessively as a result of constriction of the annular space by relatively thick filter cakes on the borehole wall, which may lead to disintegration of the formation. If the cement slurry releases too much water, it does not set completely and is permeable to gas and oil. Finally, the resulting cement jacket in the annular space must reach a certain strength as rapidly as possible and shrinkage must not occur during setting, as this would lead to flow channels for gas, oil and water.

An optimal formulation of the cement slurry properties is possible only by means of additives.

A distinction is made between 3 major groups of additives:
1. Retardants which increase the setting time so that the cement slurry remains sufficiently fluid for the entire pumping phase, which lasts for several hours in the case of very deep wells. The most well-known products of this type are lignosulfonates and carboxymethylhydroxyethylcelluloses.
2. Dispersants which homogeneously disperse the cement slurries and reduce the viscosity, which leads to better pumping thereof. As such products, U.S. Pat. No. 3,465,825 describes condensates of mononaphthalenesulfonates and formaldehyde and U.S. Pat. No. 4,053,323 describes N-sulfoalkyl-substituted acrylamides. The lignosulfonates and carboxymethylhydroxyethylcellulose ethers, too, have a dispersing effect on cement slurries in addition to the retarding effect.
3 Water-loss reducers which reduce the release of water by the cement slurries to porous formations during the pumping of the cement slurries into the annular space between casing and borehole wall. The most well-known products of this type are fully synthetic acrylate/acrylamide copolymers according to DE-B-28 30 528 and block copolymers of vinylpyrrolidone and acrylamide according to GB-B-14 73 767 and the semisynthetic carboxymethylhydroxyethyl- and hydroxyethylcellulose ethers.

The water-loss reducers are of particular importance since pumpable cement slurries which consist only of cement and water release large volumes of water when they flow past porous rock layers during cementing of the borehole. The alkaline water causes clays in the formations to swell and, with CO₂ from the natural gas or petroleum, forms precipitates of calcium carbonate. Both effects reduce the permeability of the deposits and decrease the subsequent production rates. The cement optimally formulated above ground for the respective cementing undergoes, as a result of the water release, a viscosity increase which is difficult to calculate and makes pumping more difficult. The release of water to porous formations can lead to an inhomogeneous cement material which does not solidify homogeneously and is permeable to gases, to liquid hydrocarbons and to waters. This can result in the escape of natural gas or petroleum through the annular space filled with porous cement into other formations and, in extreme cases, above ground. Furthermore, aggressive saline waters and gases can act on the casing through the porous cement and corrode said casing.

To ensure a technically satisfactory cementing of boreholes, it is necessary to reduce the water loss of the cement slurries used. The water loss is measured comparatively using a filter press according to API Code 29. The filter area is 45.8±0.7 cm², the superatmospheric pressure is 7±0.7 atm gauge pressure and the filtration time is 30 minutes. Recently, measurements of the water loss have been carried out more and more frequently by means of a high-temperature and high-pressure filter press (Baroid No. 387). Usually, filtration is carried out with a differential pressure of 35 bar, and the temperature is matched to that occurring in practice.

The semisynthetic cellulose ethers of the hydroxyethylcellulose type and partially also carboxymethylhydroxyethylcellulose ethers have been widely used to date for reducing the water loss of cement slurries. Their practical use is limited by the temperatures to which the cement slurries are exposed. The effect declines sharply above 100° C. and can then no longer be compensated by using larger amounts. Fully synthetic copolymers comprising acrylamide and acrylic acid or vinylpyrrolidone have not become established in deeper wells with higher floor temperatures. Particularly when saline waters are used for formulating the cement slurries, said copolymers have a very moderate effect which decreases further at higher temperatures. Saline waters are customary in offshore wells and are necessary when cementing salt layers. These products fail completely if CaCl₂ is used as a setting accelerator. The prior art shows that there is at present a gap in the case of products for reducing the water loss of cement slurries for deep wells, particularly if the cement slurries are exposed to temperatures above 100° C. and are formulated with saline waters.

In some cases, the additives have more than one function. Dispersants, such as lignosulfonates and polymethylenenaphthalenesulfonates, retard setting and slightly reduce water loss. Some water-loss reducers retard setting and dramatically increase viscosity.

The first highly effective water-loss reducers, which are still used today, are hydroxyethyl- and carboxymethylhydroxyethylcellulose. Hydroxyethyl-cellulose increases viscosity and slightly retards setting. Carboxymethyl-hydroxyethylcellulose has a greater retardant effect, but this can be compensated by accelerators. The effect declines markedly with increasing temperature. Consequently, many different fully synthetic polymers having higher thermal stability have been proposed and are used.

U.S. Pat. No. 3,994,852 describes polyvinylpyrrolidone polyacrylamide polymers, U.S. Pat. No. 3,943,996 methacrylamidopropenyltrimethylammonium chloride copolymers, U.S. Pat. No. 4,015,991 hydrolyzed acrylamide-acrylamido-methylenepropenylsulfonate copolymers, U.S. Pat. No. 4,340,525 acrylamide, sodium acrylate and sodium vinylsulfonate terpolymers, U.S. Pat. No. 4,413,681 reaction products of polyamine and high molecular weight sulfonated polymers, U.S. Pat. No. 4,602,685 dimethyldiallylammonium chloride-acrylic acid copolymers, EP-A-0 192 447 dimethylacrylamide-acrylamidomethylene-propenylsulfonate copolymers, U.S. Pat. No. 4,683,953 methacrylamidopropylene-trimethylammonium chloride, styrene sulfonate and acrylamide terpolymers, U.S. Pat. No. 4,742,094 reaction products comprising polyethyleneimine and sulfonated organic compounds, U.S. Pat. No. 4,568,471 hydrolyzed terpolymers of vinyl sulfonate-acrylamide-vinylamide and EP-A-0 116 671 acrylamido-methylenepropenylsulfonate, acrylamide (partially hydrolyzed) and vinylamide terpolymers, which are used in cement slurries for controlling the water loss.

The large number of compounds developed clearly shows that there are always problems in formulating an optimum cement slurry. In the case of individual parameters predetermined by the type of cementing, the other properties have to be adjusted to acceptable values by means of additives. The large numbers of compounds developed for reducing the water loss shows how problematic it generally is to establish a required water release without substantially increasing the viscosity, to establish the setting time according to requirements and to minimize the sedimentation. Water-loss reducing polymers increase to a greater or lesser extent the viscosity of the cement slurries, which generally have a high density.

For good pumpability of the cement slurries, the viscosity must be kept low. A pumping rate which permits turbulent flow should be possible. Only under these conditions is the drilling mud completely displaced. This is essential for good cementing. In the case of slanting wells, the drilling mud can be thoroughly displaced only by a strong turbulent flow.

In addition to the use as auxiliaries for formulating the cement slurries, water-soluble copolymers are also used in the so-called water shut-offs. This is the reduction of the water permeability in the area close to the probe of petroleum or natural gas and water-conveying horizons. The use of water-shutoff polymers therefore reduces or shuts off water flows to a production well.

Often, water exists as salt solution in the same formation as petroleum or natural gas. The recovery of petroleum or of natural gas thus entails the recovery of water in an amount such that it gives rise to considerable problems. It directly or indirectly causes deposition of salts in the vicinity of the well or in the well itself, it considerably increases the corrosion of all metal parts below ground or above ground, it increases, without benefits, the amounts of pumped, transferred and stored liquids and, together with the oil, it forms emulsions which are difficult to break above ground and which form blockages below ground in the cavities of the formation.

A large number of processes proposed and practiced according to the prior art are intended to reduce the water flows into the wells for recovery of petroleum or natural gas. They often comprise introducing an impenetrable barrier in the formation between the water and the well or between the water and the petroleum or natural gas. The compositions usually introduced also block almost as much petroleum or natural gas as water. The components of this barrier may be: cement, resins, suspensions of solid particles, paraffins or water-soluble polymers which are crosslinked by introducing so-called crosslinkers in the deposit.

Polymers often used are those which are introduced in solution into the porous medium, are adsorbed onto the surface of the solid and penetrate into the pore space and are therefore suitable for reducing the inflow of water by friction. In contrast, the nonaqueous fluids, such as petroleum or especially natural gas, pass the adsorbed macromolecules which now occupy a negligible volume on the wall and thus leave the passage completely free.

U.S. Pat. No. 4,095,651 discloses the use of hydrolyzed polyacrylamides. However, it has been found that this type of polymer is effective mainly with respect to water having a low salt content and is degraded by water having a higher salt content. At relatively high temperatures and in the presence of polyvalent ions, these polymers tend to form precipitates which may block the pores of the rock formation.

U.S. Pat. No. 4,718,491 discloses the use of polysaccharides. These compounds, which are poorly injectable into the pore space, do retard or reduce the water inflow but permit only incomplete extraction of the deposits present or lose their activity at higher temperatures.

U.S. Pat. No. 4,842,071 discloses the use of unhydrolyzed acrylamide polymers or copolymers which are hydrolyzed by subsequent introduction of a water-based solution. This process has disadvantages with regard to an additional effort for introducing a further solution, and due to the problem of the accessibility of the injected polymer solution owing to the subsequent application of the base solution and with respect to increased susceptibility of the equipment used to corrosion. In addition, the polymer solution becomes effective only on reaction with the water-based solution, the degree of effectiveness being determined by the degree of reaction.

A significant disadvantage of the synthetic polymers known to date is the stability thereof to biodegradation. Government environmental protection regulations frequently require a minimum level of biodegradability for the assistants used in mineral oil production if the use thereof is to be permissible.

DE-A-199 26 355 discloses copolymers which contain from 5 to 95% by weight of structural units of acrylamidosulfonates, from 1 to 95% by weight of structural units of vinylphosphonic acid, from 1 to 95% by weight of structural units of a nitrogen-containing cationic monomer, and optionally derivatives of acrylic acid and N-vinylamide. However, the biodegradability of the compounds detailed by way of example therein is inadequate.

The object of the invention was therefore to provide synthetic copolymers which can be used both in exploration, i.e. in drilling mud and cementing, and in production wells. They should be effective water-loss reducers and be suitable for water shut-offs. They should be notable for improved biodegradability compared to the copolymers of the prior art.

It has now surprisingly been found that the biodegradability of copolymers comprising structural units of acrylamido-N-methylenepropenylsulfonic acid or derivatives thereof, vinylamides and/or acrylic acid or derivatives thereof, can be considerably improved, compared to the polymers of the prior art, by the incorporation of vinylphosphonic acid or salts thereof into the copolymer. Such copolymers permit the formulation of cement slurries having low water loss. These additives also have outstanding properties as drilling mud. In addition, they are capable of selectively reducing the water permeability in natural gas- or petroleum- and water-conveying horizons to such an extent that they are suitable for water shut-off.

The invention therefore provides for the use of vinylphosphonic acid or of a salt thereof as a monomer in an amount of 0.5 to 25% by weight, based on the weight of the copolymer, for improving the biodegradability of copolymers which contain from 75 to 99.5% by weight, based on the weight of the copolymer, of structural units of one or more monomers selected from the group consisting of compounds of the

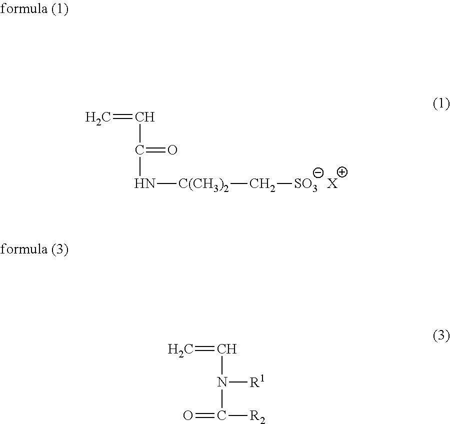

in which R¹ and R², independently of one another, are hydrogen or C₁-C₄-alkyl,

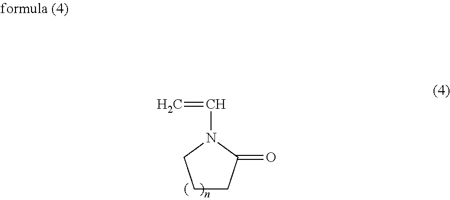

in which n is 3, 4 or 5, and

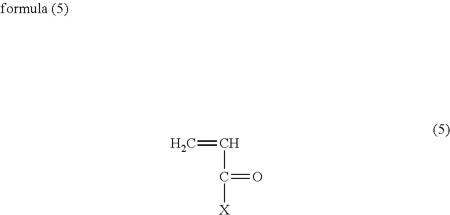

in which X is OH or NR³R⁴, and R³ and R⁴, independently of one another, are H or C₁-C₄-alkyl.

The invention further provides a process for improving the biodegradability of copolymers which contain from 75 to 99.5% by weight, based on the weight of the copolymer, of structural units of one or more monomers selected from the group consisting of compounds of the

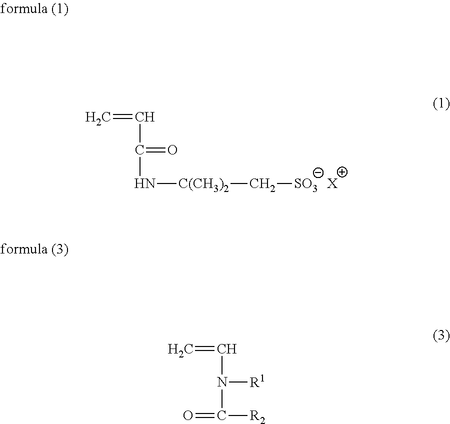

in which R¹ and R², independently of one another, are hydrogen or C₁-C₄-alkyl,

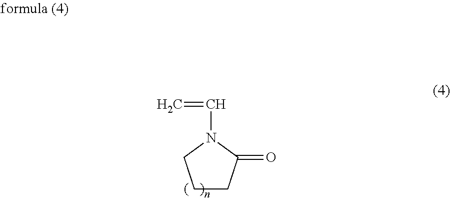

in which n is 3, 4 or 5, and

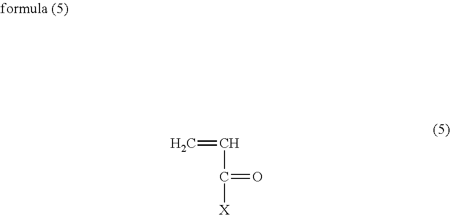

in which X is OH or NR³R⁴, and R³ and R⁴, independently of one another, are H or C₁-C₄-alkyl, by copolymerizing vinylphosphonic acid or a salt thereof in the copolymer in an amount of from 0.5 to 25% by weight, based on the weight of the copolymer.

The invention further relates to copolymers comprising
A) 50-95% by weight of structural units which are derived from compounds of the

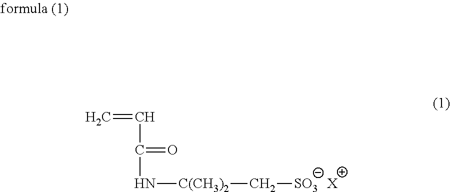

B) from 0.5 to 25% by weight of structural units which are derived from compounds of the

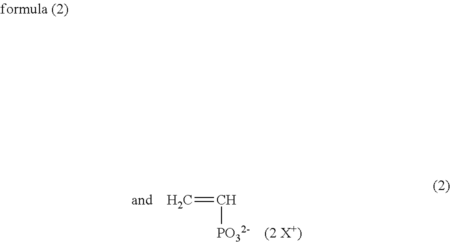

and
C) from 1 to 10% by weight of structural units which are derived from compounds of the

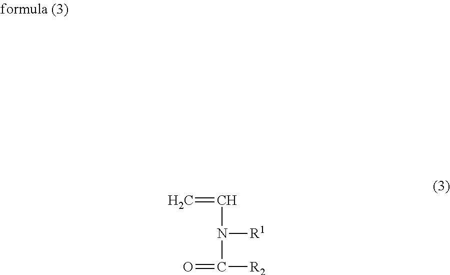

in which R¹ and R², independently of one another, are hydrogen or C₁-C₄-alkyl
D) from 1 to 10% by weight of structural units which are derived from compounds of the

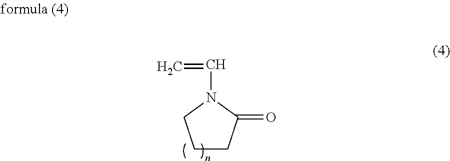

in which n is 3, 4 or 5, and

E) from 1 to 30% by weight of structural units which are derived from compounds of the

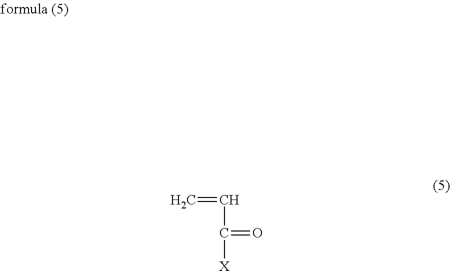

in which X is OH or NR³R⁴, and R³ and R⁴, independently of one another, are H or C₁-C₄-alkyl, with the proviso that the copolymers comprise less than 1% by weight of structural units of dialkyldimethylammonium chloride.

In all embodiments of the invention, dialkyldimethylammonium chloride is present in an amount of preferably below 1% by weight, particularly 0.001 to 1% by weight, especially 0.001 to 0.1% by weight. It is particularly preferably completely absent.

In all embodiments of the invention, the proportion by weight of vinylphosphonic acid or salts thereof is preferably from 0.8 to 2.2, especially from 1 to 2% by weight, based in each case on the total weight of all monomers in the copolymer. Suitable salts of vinylphosphonic acid are preferably the alkali metal or ammonium salts thereof.

In all embodiments of the invention, the proportion by weight of the monomers of the formulae (1), (3), (4) and (5) is preferably from 97.8 to 99.2, especially from 98 to 99% by weight, based in each case on the total weight of all monomers in the copolymer.

In a preferred embodiment, the proportion of structural units which are derived from compounds of the formula (1) in all embodiments of the invention is up to 95% by weight, preferably from 60 to 90, especially from 70 to 85% by weight.

The proportion of structural units which are derived from compounds of the formula (3) is preferably from 1 to 10, particularly from 2 to 8, especially from 3 to 7% by weight.

The proportion of structural units which are derived from compounds of the formula (4) is preferably from 1 to 10, particularly from 2 to 8, especially from 3 to 7% by weight.

The proportion of structural units which are derived from compounds of the formula (5) is preferably from 1.5 to 25, especially from 2 to 23% by weight. Formula (5) preferably represents acrylic acid and/or acrylamide. If formula (5) represents only acrylamide, the proportion thereof is preferably from 1.5 to 25, especially from 2 to 23% by weight. If formula (5) represents acrylic acid and acrylamide, the proportion of acrylic acid is preferably from 0.5 to 5% by weight, especially from 2 to 4% by weight, and the proportion of acrylamide is preferably from 20 to 25, especially from 21 to 24% by weight.

The monomer units may be in any sequence in the copolymers. They may be either random polymers or block polymers.

The molecular weights (number average) of the copolymers according to the invention are preferably from 50,000 to 3,000,000 g/mol, in particular, products from 200,000 to 1,000,000 g/mol are used.

The relative viscosity and the k value serve as indicator for the molecular weight. To determine the k value, the copolymer is dissolved in a certain concentration (generally 0.5%) and the efflux time at 25° C. is determined by means of an Ubbelohde capillary viscometer. This value gives the absolute viscosity of the solution (η_{c}). The absolute viscosity of the solvent is η₀. The ratio of the two absolute viscosities gives the relative viscosity

$$z = \frac{{η}_{c }}{{η}_{0}}$$

From the relative viscosities, the k value can be determined as a function of the concentration by means of the following equation:

$$Lgz = ( \frac{75 \cdot {k}^{2}}{1 + 1.5 kc} + k ) c$$

The copolymers according to the invention can be prepared by copolymerization of compounds of the formulae (1), (2) and (3), (4) and (5), in the stated ratios.

The copolymers according to the invention can be prepared by the conventional polymerization methods, such as solution polymerization, mass polymerization, emulsion polymerization, inverse emulsion polymerization, precipitation polymerization or gel polymerization. They are preferably the product of a free-radical copolymerization of the compounds of the formulae (1), (2), (3), (4) and (5).

The polymerization is preferably carried out as solution polymerization in water and as precipitation polymerization.

On carrying out the copolymerization in a water-miscible organic solvent, the conditions of precipitation polymerization are employed. Here, the copolymer is obtained directly in solid form and can be isolated by distilling off the solvent or filtering with suction and drying.

Water-miscible organic solvents which are suitable here are in particular water-soluble alkanols, i.e. those having 1 to 4 carbon atoms, such as methanol, ethanol, propanol, isopropanol, n-butanol, sec-butanol and isobutanol, but preferably tert-butanol.

The water content of the lower alkanols used here as solvent should not exceed 6% by weight, since otherwise agglomeration may occur during the polymerization. Preferably, a water content of 0 to 3% by weight is employed.

The amount of the solvent to be used depends to a certain degree on the type of comonomers used. As a rule, from 200 to 1000 g of the solvent are used per 100 g of total monomers.

When carrying out the polymerization in an inverse emulsion, the aqueous monomer solution is emulsified in a known manner in a water-immiscible organic solvent, such as cyclohexane, toluene, xylene, heptane or high-boiling gasoline fractions, with the addition of from 0.5 to 8% by weight, preferably from 1 to 4% by weight, of known emulsifiers of the w/o type and polymerized with conventional free radical initiators. In this process, water-soluble monomers or mixtures thereof are polymerized at elevated temperatures to give high molecular weight copolymers by first emulsifying the monomers or the aqueous solutions thereof, with the addition of water-in-oil emulsifiers, in water-immiscible organic solvent forming the continuous phase, and heating this emulsion in the presence of free radical initiators. The comonomers to be used may be emulsified as such in the water-immiscible organic solvent or they may be used in the form of an aqueous solution which contains from 100 to 5% by weight of comonomers and from 0 to 95% by weight of water, the composition of the aqueous solution depending on the solubility of the comonomers in water and on the intended polymerization temperature. The weight ratio of water to the monomer phase can be varied within wide limits and is as a rule from 70:30 to 30:70.

To emulsify the monomer phase in the water-immiscible organic solvent to give a water-in-oil emulsion, from 0.1 to 10% by weight, based on the oil phase, of a water-in-oil emulsifier are added to the mixtures. Preferably used emulsifiers are those which have a relatively low HLB value. The oil phase used can in principle be any inert water-insoluble liquid, i.e. in principle any hydrophobic organic solvent. In general, hydrocarbons whose boiling point is in the range from 120 to 350° C. are used. These hydrocarbons may be saturated, linear or branched paraffin hydrocarbons, as are predominantly present in petroleum fractions, it also being possible for these to comprise the usual proportions of naphthene hydrocarbons.

However, aromatic hydrocarbons, such as, for example, toluene or xylene, and mixtures of the abovementioned hydrocarbons may also be used as the oil phase. A mixture of saturated normal paraffin and isoparaffin hydrocarbon which comprises up to 20% by weight of naphthenes is preferably used.

Copolymers having a particularly high degree of polymerization in the base chains are obtained as polymerization is carried out in aqueous solution by the so-called gel polymerization method. From 15 to 60% strength aqueous solutions of the comonomers are obtained with known suitable catalysts without mechanical mixing, with utilization of the Trommsdorff-Norrisch effect.

By subsequently heating the polymer gels, obtained in the gel polymerization, in the temperature range from 50 to 130° C., preferably from 70 to 100° C., the quality properties of the polymers can be further improved.

The copolymers prepared by this method and present in the form of aqueous gels can be dissolved directly in water after mechanical comminution using suitable apparatuses and can be used. However, they can also be obtained in solid form after removal of the water by known drying processes and not dissolved again in water until they are used.

The polymerization reaction is carried out in the temperature range from −60° C. to 200° C., preferably from 10 to 120° C., it being possible to employ either atmospheric pressure or superatmospheric pressure. As a rule, the polymerization is carried out in an inert gas atmosphere, preferably under nitrogen.

High-energy electromagnetic or corpuscular radiation or conventional chemical polymerization initiators can be used for initiating the polymerization, for example organic peroxides, such as benzyl peroxide, tert-butyl hydroperoxide, methyl ethyl ketone peroxide or cumyl hydroperoxide, azo compounds, such as azobisisobutyronitrile or 2′-azobis(2-amidopropane) dihydrochloride, and inorganic peroxy compounds, such as (NH₄)₂S₂O₈ or K₂S₂O₈ or H₂O₂, if required in combination with reducing agents, such as sodium bisulfite and iron(II) sulfate, or redox systems which comprise an aliphatic or aromatic sulfinic acid, such as benzenesulfinic acid or toluenesulfinic acid or derivatives of these acids, such as, for example, Mannich adducts or sulfinic acid, aldehydes and amino compounds, as a reducing component. As a rule, from 0.03 to 2 g of the polymerization initiator are used per 100 g of total monomers.

It is furthermore known that small amounts of so-called moderators may be added to the polymerization batches, said moderators harmonizing the course of the reaction by flattening the reaction rate/time diagram. They thus lead to an improvement in the reproducibility of the reaction and therefore make it possible to prepare uniform products having extremely small quality deviations. Examples of suitable moderators of this type are nitrilotrispropionylamide, monoalkylamines, dialkylamines or trialkylamines, such as, for example, dibutylamine. Such moderators can advantageously also be used in the preparation of the copolymers according to the invention.

Furthermore, so-called regulators, i.e. those compounds which influence the molecular weight of the polymers prepared, can be added to the polymerization batches. Known regulators which may be used are, for example, alcohols, such as methanol, ethanol, propanol, isopropanol, n-butanol, sec-butanol and amyl alcohols, alkyl mercaptans, such as, for example, dodecyl mercaptan and tert-dodecyl mercaptan, isooctyl thioglycolate and some halogen compounds, such as, for example, carbon tetrachloride, chloroform and methylene chloride.

The copolymers according to the invention are outstandingly suitable as auxiliaries in drilling muds. Their biodegradability is considerably superior to that of the copolymers of the prior art.

For formulating aqueous drilling muds, the copolymers according to the invention are preferably used in concentrations from 0.5 to 40 kg/m³, in particular from 3 to 30 kg/m³. The aqueous drilling muds furthermore contain bentonite for increasing the viscosity and sealing drilled formations. For increasing the density of the drilling muds, barite, chalk and iron oxides are added.

Bentonite, barite, chalk and iron oxide can be added to the drilling muds alone or in a very wide range of mixing ratios, it being necessary to retain the rheological properties of the drilling muds. If the copolymers according to the invention are added to conventional deep-well cement slurries which preferably comprise 30-65% by weight, in particular 35-55% by weight, based on the dry cement used, of water, cement slurries having considerably improved flow and setting properties and having low water loss are obtained.

The polymers according to the invention are preferably added in amounts of 0.1-2.0% by weight, based on the cement used, to cement slurries of conventional composition which, based on, for example, “Class G” deep-well cement, contain, for example, 44% by weight of water, 0.1-2.0% by weight of commercial dispersant for deep-well cement and, if required, retardants or accelerators and other additives. Depending on requirements, the cement slurry can, for example, also be mixed with synthetic sea water or with NaCl solutions of different densities to saturation instead of with water.

The quality of the cement slurries thus prepared with the copolymers according to the invention is assessed according to API spec 10. Cement slurries having advantageously low plastic viscosity, low water loss and setting time controllable according to the requirements are obtained in a temperature range of 60-200° C.

The copolymers according to the invention are furthermore preferably used for reducing or completely shutting off the water flow in wells in sandstone, carbonate rock or silicate rock.

By modifying the copolymers used, the absorptivity of the copolymer can be adapted to the type of rock present. By so-called anionic modification of the copolymers used, the absorption of carbonate-containing rocks can be improved. Anionic modification is usually achieved by a proportion of structural units of the formula (1) and in particular of the formula (2) in copolymers.

By so-called cationic modification of the copolymers used, the absorption on silicate-containing rocks can be improved. Cationic modification is usually achieved by a proportion of structural units of the formulae (3) or (4).

The copolymers according to the invention contain both structural units of the formulae (1) and (2) and those of the formulae (3) or (4). They thus reduce the relative water permeability by improved adsorption onto carbonate-containing rock and onto silicate-containing rocks and onto the frequently occurring mixed forms.

For completion and clearing-out liquids, for example, CaCl₂ (max. 1.40 g/cm³), CaBr₂—(max. 1.71 g/cm³) or CaCl₂/CaBr₂ (max. 1.81 g/cm³) solutions are used, it being necessary for said solution to have a low water loss at higher temperatures too.

The preparation and use of the copolymers according to the invention are illustrated by the following examples.

### EXAMPLES

TABLE 1
Composition of the copolymers in % by weight

| Copolymer | AMPS | VPS | NVA | NVP | AS | AA |
|---|---|---|---|---|---|---|
| 1 | 84 | 1.9 | 4.7 | 4.7 | 0 | 4.7 |
| 2 | 72.5 | 1.2 | 1.4 | 0 | 2.5 | 22.4 |
| 3 | 74.8 | 1.5 | 1.1 | 0 | 0 | 22.6 |
| C1 | 85 | 0 | 5 | 5 | 0 | 0 |
| C2 | 73.3 | 0 | 1.5 | 0 | 2.6 | 22.6 |
| C3 | 76.0 | 0 | 1.1 | 0 | 0 | 22.9 |

AMPS ® = Acrylamidopropenylsulfonic acid
VPS = Vinylphosphonic acid
VPS = Vinylphosphonic acid ammonium salt
NVA = N-Vinylformamide
NVP = N-Vinylpyrrolidone
AS = Acrylic acid
AA = Acrylamide

TABLE 2
Biodegradabity according to OECD 306; in %

Days

| Copolymer | 7 | 14 | 21 | 28 |
|---|---|---|---|---|
| 1 | 3.3 | 0.7 | 12.2 | 27.2 |
| 2 | 0 | 13 | 17 | 35 |
| 3 | 0 | 7 | 20 | 22 |
| C1 | 4 | 7 | 7 | 3 |
| C2 | 2 | 5 | 6 | 4 |
| C3 | 3 | 3 | 4 | 5 |

1. A copolymer with improved biodegradability comprising a vinylphosphonic acid or of a salt thereof as a monomer in an amount of 0.5 to 25% by weight, based on the weight of the copolymer, obtained by free-radical copolymerization of the compounds of the formulae (1), (3), (4), (5) and vinylphosphonic acid or salts thereof and contain from 75 to 99.5% by weight, based on the weight of the copolymer, of structural units of one or more monomers selected from the group consisting of compounds of the 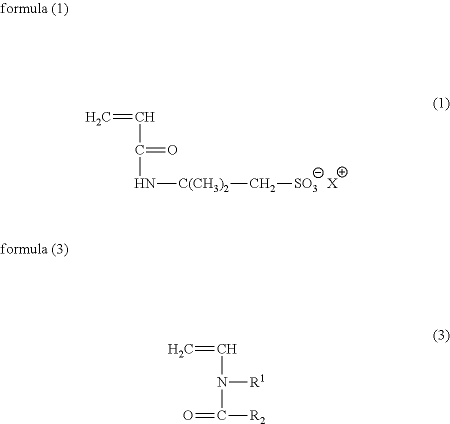
wherein R¹ and R², independently of one another, are hydrogen or C₁-C₄-alkyl, 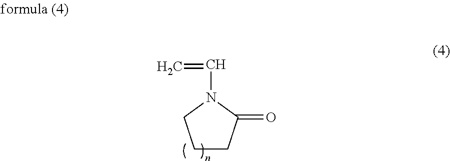
wherein n is 3, 4 or 5, and 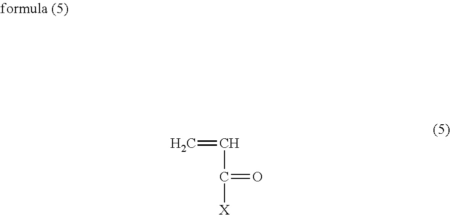
wherein X is OH or NR³R⁴, and R³ and R⁴, independently of one another, are H or C₁-C₄-alkyl.

2. A copolymer as claimed in claim 1, wherein the content in the copolymer of structural units derived from compounds of the formula (1) is from 60 to 90% by weight.

3. A copolymer as claimed in claim 1, wherein the content in the copolymer of structural units derived from vinylphosphonic acid or salts thereof is from 0.8 to 2.2% by weight.

4. A copolymer as claimed in claim 1, wherein the content in the copolymer of structural units derived from compounds of the formula (3) is from 2 to 8% by weight.

5. A copolymer as claimed in claim 1, wherein the content in the copolymer of structural units derived from compounds of the formula (4) is from 2 to 8% by weight.

6. A copolymer as claimed in claim 1, wherein the content in the copolymer of structural units derived from compounds of the formula (5) is from 2 to 25% by weight.

7. A copolymer as claimed in claim 1, wherein the proportion of acrylic acid in the copolymer is 0.5 to 5% by weight and the proportion of acrylamide in the copolymer is 20 to 25% by weight.

8. A process for reducing the water loss of borehole cement comprising the step of adding at least one copolymer according to claim 1 to a borehole cement.

9. A process for reducing the water loss of drilling muds comprising the step of adding at least one copolymer according to claim 1 to a drilling mud.

10. A process for reducing the water permeability in petroleum-, natural gas- and water-conveying horizons in the area close to the probe comprising the step of adding at least one copolymer according to claim 1 to the area close to the probe.

11. A process for reducing the water loss in completion and clearing-out liquids comprising the step of adding at least one copolymer according to claim 1 to the completion and clearing-out liquids.

12. A process for improving the biodegradability of copolymers which contain from 75 to 99.5% by weight, based on the weight of the copolymer, of structural units of one or more monomers selected from the group consisting of compounds of the 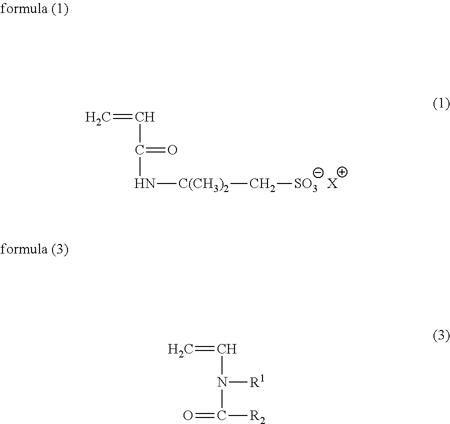
in which R¹ and R², independently of one another, are hydrogen or C₁-C₄-alkyl, 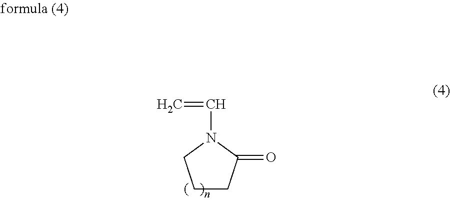
in which n is 3, 4 or 5, and 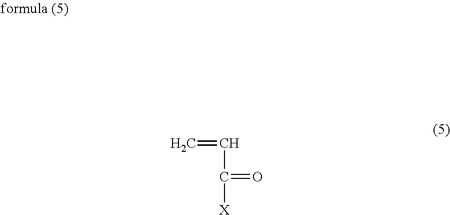
in which X is OH or NR³R⁴, and R³ and R⁴, independently of one another, are H or C₁-C₄-alkyl, by free-radically copolymerizing vinylphosphonic acid or a salt thereof in the copolymer in an amount of 0.5 to 25% by weight, based on the weight of the copolymer, with the compounds of the formulae (1), (3), (4), (5).
